(19) United States
(12) Patent Application Publication
(10) Pub. No.: US 2021/0030206 A1
(43) Pub. Date: Feb. 4, 2021

(54) Herb Grinder and with Ground Herb Storage

(71) Applicant: MICHAEL TRZECIESKI, Toronto (CA)

(72) Inventor: MICHAEL TRZECIESKI, Toronto (CA)

(21) Appl. No.: 16/945,818

(22) Filed: Aug. 1, 2020

Related U.S. Application Data
(60) Provisional application No. 62/882,200, filed on Aug. 2, 2019.

(51) Int. Cl. A47J 42/34; B02C 18/08; B02C 18/18

(52) U.S. Cl. CPC A47J 42/34; B02C 18/186; B02C 18/08

(57) ABSTRACT

A novel herb grinder is disclosed having a top portion comprising a first plurality of teeth protruding axially from a bottom surface of the top portion and an upper chamber for receiving the protruding first plurality of teeth, the upper chamber rotatably coupled to the top portion, the upper chamber for forming a first cavity into which an herbal material for grinding may be placed. The upper chamber comprising a second plurality of teeth protruding from a lower surface of the first cavity, extending axially towards the first plurality of teeth of the top portion. A central axis common to the top portion and the upper chamber about which the first plurality of teeth are for rotating with respect to the second plurality of teeth in a reciprocating motion for shredding the herb material for grinding wherein some of the first plurality of teeth and some of the second plurality of teeth comprise five sides with cutting edges formed at the sides of the teeth wherein the first plurality of teeth and the second plurality of teeth are interdigitated when the top portion is coupled with the upper chamber.

### CROSS-REFERENCE TO RELATED APPLICATIONS

This application claims the benefit of U.S. Provisional Application No. 62/882,200 filed Aug. 2, 2019, the entirety of which is incorporated herein by reference.

### FIELD OF THE INVENTION

This application relates generally to grinding of leafy phyto materials, and more specifically to devices for grinding of leafy phyto materials.

### INTRODUCTION

The following is intended to introduce the reader to the detailed description that follows and not to define or limit the claimed subject matter.

There are many different types of herbal grinders on the market for grinding of leafy herbal materials. However, some of these grinders do not provide for uniform grind, in other cases some of these grinders do not provide for an outside surface that is easy to grip and in some other cases these grinders are not ergonomic and not easy to use.

It is therefore an object of the present invention to provide a grinder for grinding of leafy herb materials that facilitates providing uniform grind as well as ergonomic operation.

### SUMMARY

The following introduction is provided to introduce the reader to the more detailed description to follow and not to limit or define any claimed or as yet unclaimed invention. One or more inventions may reside in any combination or sub-combination of the elements or process steps disclosed in any part of this document including its claims and figures.

In accordance with an aspect of this disclosure, there is provided A herb grinder comprising: a top portion comprising a first plurality of teeth protruding axially from a bottom surface of the top portion; an upper chamber for receiving the protruding first plurality of teeth, the upper chamber rotatably coupled to the top portion, the upper chamber for forming a first cavity into which an herbal material for grinding may be placed; the upper chamber comprising a second plurality of teeth protruding from a lower surface of the first cavity, extending axially towards the first plurality of teeth of the top portion, a central axis common to the top portion and the upper chamber about which the first plurality of teeth are for rotating with respect to the second plurality of teeth in a reciprocating motion for shredding the herb material for grinding; wherein some of the first plurality of teeth and some of the second plurality of teeth comprise five sides comprising an inner side facing the central axis and an outside side facing away from the central axis and third and fourth sides abutting the outside side and the inner side that form four sides and capped by a fifth side where the third and fourth sides may have an approximately same surface area and the first side may have a lower surface area than the third and fourth side and the second side having a larger surface area than the third and fourth sides, wherein the first plurality of teeth and the second plurality of teeth are interdigitated when the top portion is coupled with the upper chamber, wherein the edges abutting the sides, which are herbal material shredding edges may be approximately parallel with the axis of rotation

In accordance with an aspect of this disclosure, there is provided A method of grinding phyto material comprising: providing a grinder having a top portion comprising a first plurality of teeth protruding from a bottom surface of the top portion; providing an upper chamber, the upper chamber rotatably coupled to the top portion, the upper chamber for forming a first cavity; providing a second plurality of teeth protruding from a lower surface of the first cavity, extending towards the first plurality of teeth of the top portion; placing unground phyto material into the first cavity proximate the second plurality of teeth; interdigitating of the first plurality of teeth with respect to the second plurality of teeth; crushing the unground phyto material between the top portion and the upper chamber and the lower surface where at least some of the first and second pluralities of teeth engage the unground herbal material; providing a central axis common to the top portion and the upper chamber; rotating of the first plurality of teeth with respect to the second plurality of teeth in a reciprocating motion about the central axis for shredding the phyto material for grinding; wherein some of the first plurality of teeth and some of the second plurality of teeth comprise five sides comprising an inner side facing the central axis and an outside side facing away from the central axis and third and fourth sides abutting the outside side and the inner side that form four sides and capped by a fifth side where the third and fourth sides may have an approximately same surface area and the first side may have a lower surface area than the third and fourth side and the second side having a larger surface area than the third and fourth sides, wherein the edges abutting the sides, which are herbal material shredding edges may be approximately parallel with the axis of rotation.

In accordance with an aspect of this disclosure, there is provided A method of grinding phyto material comprising: providing a grinder having a top portion comprising a first plurality of teeth protruding from a bottom surface of the top portion; providing an upper chamber, the upper chamber rotatably coupled to the top portion, the upper chamber for forming a first cavity placing unground herb material into the first cavity, a second plurality of teeth protruding from a lower surface of the first cavity, extending towards the first plurality of teeth of the top portion, providing a plurality of apertures being defined by the lower surface of the first cavity that passes through the upper chamber, the aperture allowing ground herbs to exit the upper chamber once ground; providing a lower chamber coupled with the upper chamber, the lower chamber comprising a second cavity, the lower chamber removably connected to the upper chamber, the plurality of aperture of the upper chamber communicating with the second cavity of the lower chamber; crushing unground herbal material between the top portion and the upper chamber where the first and second pluralities of teeth engage the unground herbal material; rotating the top portion and the upper chamber in opposite directions and thereby grinding the unground herbal material between the first and second pluralise of teeth, the ground herbs passing through the aperture into the second cavity of the lower chamber; providing a filling container aperture formed by an edge wall of the lower chamber, the filling container aperture having an open position allowing passage of the ground herbs out of the lower chamber cavity into a mouth of the coupled filling container; uncoupling of the storage container from the filling container aperture with the ground herbal material being stored in the storage container.

In some embodiments the upper chamber comprises an inside circumference and wherein the top portion comprises an outer circumference wherein when the upper chamber may be coupled with the top portion, a gap may be formed about the inside circumference wherein the inside circumference has a smaller diameter than the outer circumference.

In some embodiments a plurality of apertures being defined by the lower surface of the first cavity that passes through the upper chamber, the aperture allowing ground herbs to exit the upper chamber once ground through at least some of the plurality of apertures.

In some embodiments a lower chamber comprising a second cavity, the lower chamber removably connected to the upper chamber, the plurality of aperture of the upper chamber communicating with the second cavity of the lower chamber.

In some embodiments a spout formed by an edge wall and an upper surface of the lower chamber, the spout having an open position allowing passage of the ground herbs out of the lower chamber cavity when the upper chamber may be uncoupled from the lower chamber, and having a closed position preventing passage of the ground herbs out of the second cavity of the lower chamber when the upper chamber may be coupled with the lower chamber.

In some embodiments wherein when the herb grinder is viewed from a top view that is perpendicular with the central axis the herb grinder comprises an ovate shape.

In some embodiments the ovate shape comprises a cuboid structure having four radiused comprising a first radius, a second radius, a third radius and a fourth radius, wherein the second radius may be found opposite the first radius along and bisected by a first axis and a perpendicular radial axis bisects third and fourth radii where the third radius may be may be larger than the first radius and fourth radius may be larger than the second radius and the second radius may be smaller than the third radius and the fourth radius and first radius.

In some embodiments a filling container aperture formed by an edge wall of the lower chamber, the filling container aperture having an open position allowing passage of the ground herbs out of the lower chamber cavity and comprising a storage container for being releasably coupled with the filling container aperture for collecting the ground herbs and a lid for being releasably coupled with the filling container aperture when the storage container is other than coupled with the filling container aperture.

In some embodiments the first cavity may be magnetically connected to the top portion.

In some embodiments the bottom portion may be one of magnetically connected to the lower chamber and threaded connection to the low chamber.

In some embodiments at least one of the four sides may be concave and comprise a diameter of curvature.

In some embodiments the four sides may be concave and each comprise a diameter of curvature wherein the first side has a smaller diameter of curvature than the third and fourth side diameters of curvature and the second side has a diameter of curvature larger than the diameter of curvature than the third and fourth side.

In some embodiments providing a plurality of apertures being defined by the lower surface of the first cavity that passes through the upper chamber, the aperture allowing ground herbs to exit the upper chamber once ground.

In some embodiments providing a lower chamber coupled with the upper chamber, the lower chamber comprising a second cavity, the lower chamber removably connected to the upper chamber, the plurality of aperture of the upper chamber communicating with the second cavity of the lower chamber.

In some embodiments uncoupling of the lower chamber from the upper chamber and removing of the ground herbs from the second cavity.

### BRIEF DESCRIPTION OF THE DRAWINGS

FIG. 1A illustrates a herb grinder as a first embodiment of the invention in an exploded and perspective view.

FIG. 1B illustrates a herb grinder as a first embodiment of the invention with an upper chamber coupled with a lower chamber and top portion uncoupled from the upper chamber;

FIG. 1C illustrates a herb grinder as a first embodiment of the invention with an upper chamber uncoupled with a lower chamber and top portion not shown;

FIG. 1D illustrates a herb grinder when viewed from the top and resembling an approximately egg or ovate shape;

FIG. 1E illustrates a top portion may be engaged with an upper chamber and the top portion may be rotated about a central axis relative to the upper chamber in a reciprocating motion;

FIG. 1F illustrates a single tooth from a second and third set of teeth from the from the plurality of teeth;

FIG. 1G illustrates a plurality of apertures and plurality of second teeth from a top view;

FIG. 1H illustrates a first plurality of teeth from a top view;

FIG. 2A illustrates a herb grinder in a closed view with a storage container attached in accordance with a second embodiment of the invention;

FIG. 2B illustrates a herb grinder with a storage container removed and a plug or a lid inserted into a filling container aperture;

FIG. 2C illustrates a storage container removed from a filling container aperture and a top portion removed to show a second plurality of teeth;

FIG. 2D illustrates a storage container attached with a filling container aperture and an upper chamber removed;

FIG. 2E illustrates an exploded view of the second embodiment of the invention with a storage container attached with a filling container aperture;

FIG. 2F illustrates a perspective view of the herb grinder showing an ovate shape;

FIG. 2G illustrates a plug or a lid being removably attached with a filling container aperture;

FIG. 2H illustrates a first plurality of teeth and a second plurality of teeth being interdigitated when a top portion is coupled with an upper chamber; and,

FIG. 3A illustrates a herb grinder in accordance with a third embodiment of the invention from an exploded view.

### DETAILED DESCRIPTION

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising,” and variations thereof mean “including but not limited to,” unless expressly specified otherwise. A listing of items does not imply that any or all of the items are mutually exclusive, unless expressly specified otherwise. The terms “a,” “an,” and “the” mean “one or more,” unless expressly specified otherwise.

Embodiments described herein relate generally to grinding of leafy material, such as phyto materials and phyto material products. Phyto material products may be derived from phyto materials such as the leaves or buds of cannabis plants.

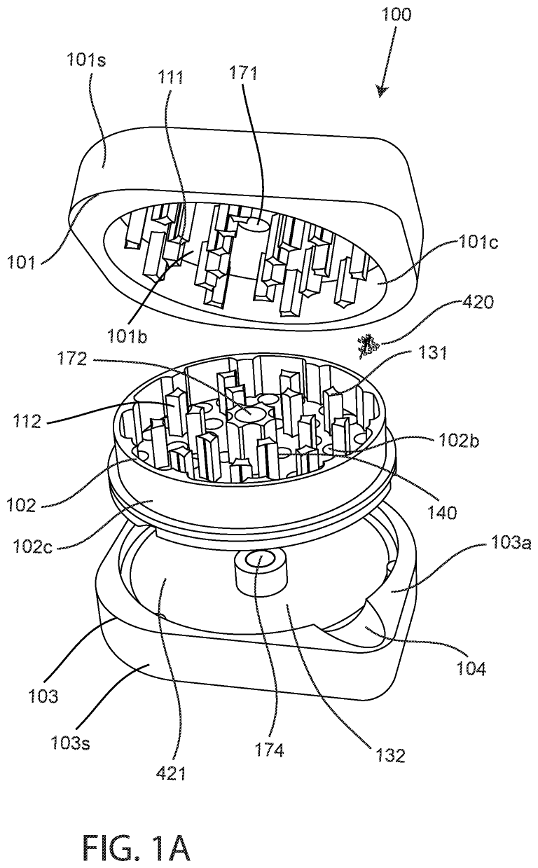

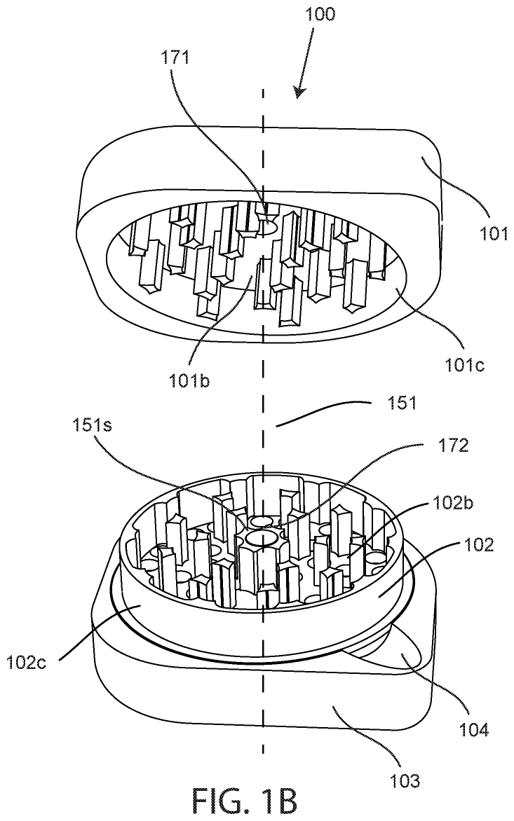

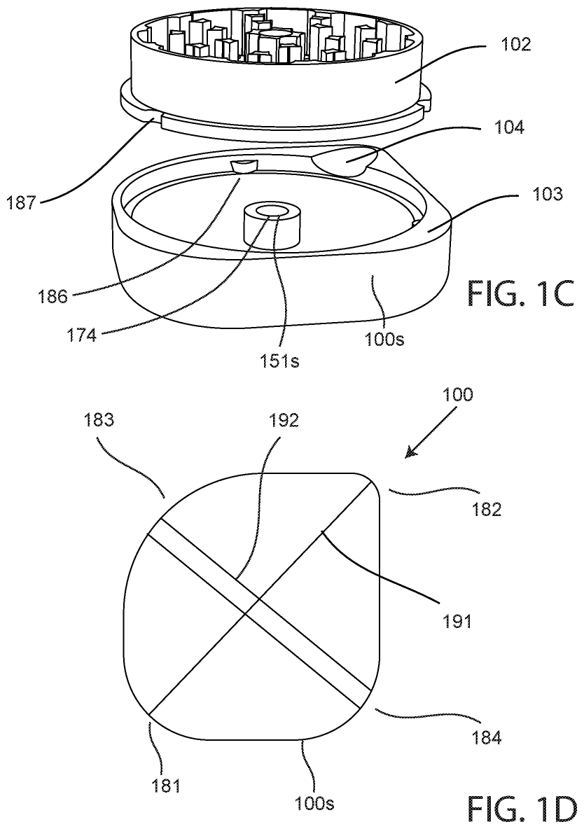

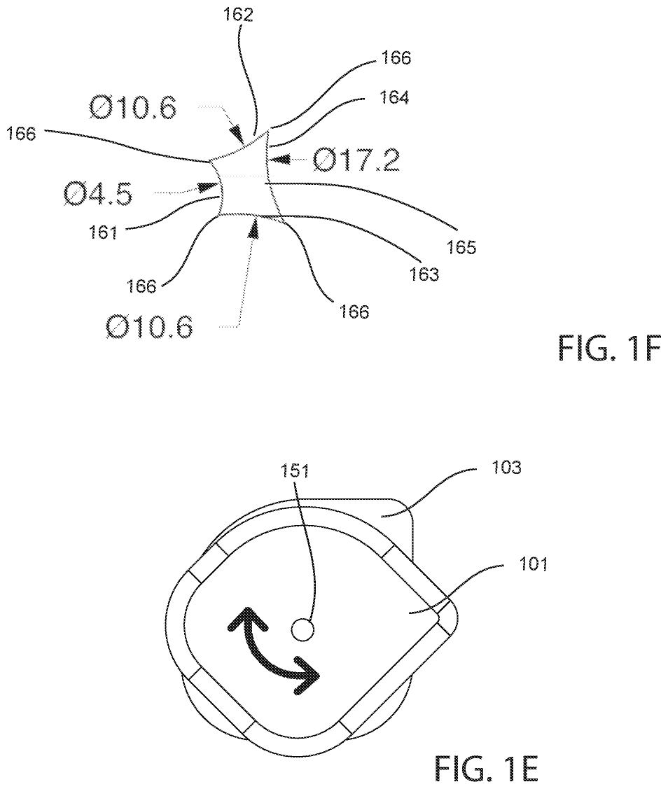

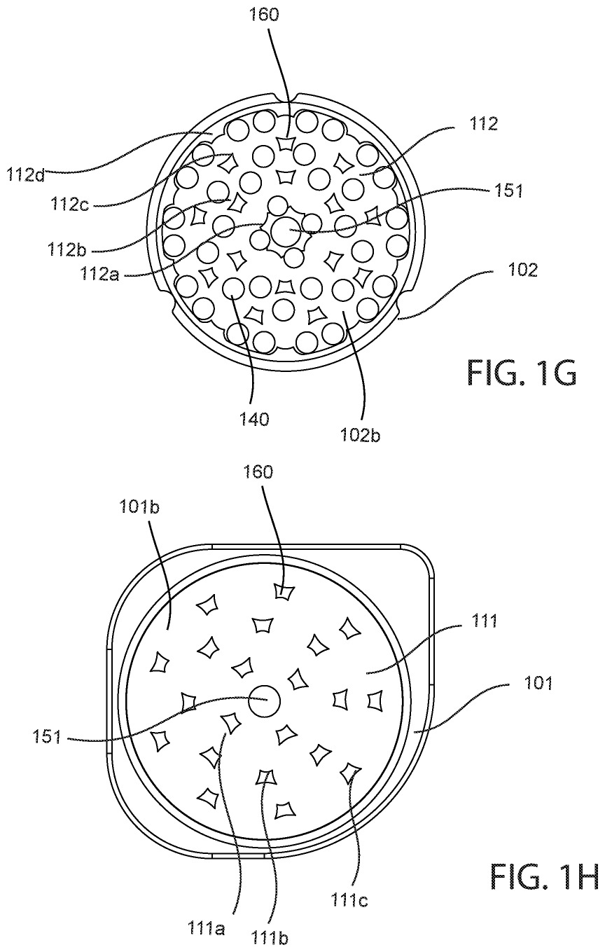

Referring to FIG. 1A a herb grinder 100 may be shown as a first embodiment of the invention in an exploded and perspective view. The herb grinder 100 may be formed from a top portion 101 and upper chamber 102 and a lower chamber 103 and may include a spout 104.

The top portion 101 comprises a first plurality of teeth 111 protruding axially from a bottom surface 101b of the top portion towards an upper chamber 102. The upper chamber 102 may be rotatably coupled to the top portion 101 where the upper chamber may be for forming a first cavity 131 into which a phyto or herbal material for grinding 420 may be placed. The first plurality of teeth 111 protruding axially from a bottom surface 101b of the top portion towards an upper chamber 102 may extend about 8-9 mm.

A second plurality of teeth 112 protruding from a lower surface 102b of the first cavity 131, extending towards the first plurality of teeth 111 of the top portion 101. A plurality of apertures 140 being defined by the lower surface 102b of the first cavity 131 that passes through the upper chamber 102, the aperture allowing ground herbs 421 to exit the upper chamber 102 once ground. The second plurality of teeth 112 protruding from a lower surface 102b of the first cavity 131, extending towards the first plurality of teeth 111 of the top portion 101 may extend about 8-9 mm.

The first plurality of teeth 111 protruding axially from a bottom surface 101b of the top portion towards an upper chamber 102 may be configured such that a distal end of the tooth that Is proximate the lower surface of the first cavity does not touch the lower surface of the first cavity. A gap of about 0.5 millimetres are so maybe envisaged.

A second plurality of teeth 112 protruding from a lower surface 102b of the first cavity 131, extending towards the first plurality of teeth 111 of the top portion 101 may be oriented such that the distal end of the tooth proximate the bottom surface 101b of the top portion does not touch the distal end of the tooth. A gap of about 0.5 millimetres are so maybe envisaged.

The first and second plurality of teeth, may be formed using a CNC machining process as is well-known in the art. The first and second plurality of teeth may be machine from aluminium or titanium or metal material or may also be injection moulded from a plastic such as a hard plastic such as a polycarbonate or other type of thermoplastic material.

FIG. 1G illustrates the second plurality of teeth 112 from a top view. The second plurality of teeth may be formed from a first set of teeth 112a which are disposed about a first diameter about a central axis 151 or a rotational axis (FIG. 1B) and a second set of teeth 112b radially extend from the rotational axis 151 and may be oriented about a second diameter and a third set of teeth may be radially spaced from the second set of teeth and also oriented about a third diameter 112c and a four set of teeth 112d may be radially space from the third set of teeth about a fourth diameter.

The first set may comprise four teeth, the second set may comprise six teeth, the third set may comprise nine teeth and the fourth set may comprise ten teeth.

FIG. 1F Illustrative a single tooth 160 from the second and third set of teeth from the from the plurality of teeth. These teeth may be formed from five surfaces or five sides with four sides extending from lower surface 102b and being caped by an end capping surface or fifth side 165 and approximating a mesa structure. An inner side, or first side, 161 facing the central axis 151, with an outside side 164, or second side, facing away from the central axis, and two sides, third and fourth sides, 162, 163 opposite each other and, abutting the outside side 164 and the inner side 161 that form the four sides. The tooth may extend from a respective floor or ceiling by about 8-10 mm. The edges 166 abutting the four sides, which are herbal material cutting edges or shredding edges may be approximately parallel with the axis of rotation 151 and the fifth side 165 may be approximately parallel with at least one of the bottom surface and the lower surface.

The third and fourth sides may have an approximately same surface area and the first side may have a lower surface area than the third and fourth side and the second side may have a higher surface area than at least one of the third and fourth sides.

In some embodiments, at least one of the sides may be concave and in some embodiments at least two of the sides may be concave and in some embodiments all the sides may be concave. The first side maybe concave having a diameter of curvature of 4.5 mm. The third and fourth sides may be concave having a diameter of curvature of approximately 10.6 mm. The second side maybe concave having a diameter of curvature of approximately 17.2 mm.

FIG. 1H illustrates the first plurality of teeth 111 from a top view. The first plurality of teeth may be formed from a fifth set of teeth 111a which are disposed about a fifth diameter about the central axis 151 or a rotational axis (FIG. 1B) and a second set of teeth 111b radially extend from the rotational axis 151 and may be oriented about a sixth diameter and a third set of teeth 111c may be radially spaced from the second set of teeth and also oriented about a seventh diameter. The first set may comprise four teeth, the second set may comprise eight teeth, the third set may comprise nine teeth.

In some embodiments, the fifth diameter is larger than the first diameter and is second diameter is larger than fifth diameter and is sixth diameter is larger than the second diameter and the third diameter is larger than the sixth diameter and seventh diameter is larger than the third diameter and the fourth diameter is larger than seventh diameter.

Referring to FIG. 1B, the upper chamber 102 may be coupled with the top portion 101 and an outer circumference 102c of the upper chamber couples with an inside circumference 101c of the top portion 101. When the upper chamber may be coupled with the top portion, a gap may be formed about the inside circumference and between the inside circumference, for example this gap may be approximately 0.1 to 0.5 mm. A diameter of the outer circumference may be 54.5 mm and a diameter of the inside circumference 101c may be about 54 mm wherein the inside circumference has a smaller diameter than the outer circumference.

Of course, other diameters are also envisaged and the gap is provided for facilitating rotation of the outer circumference of the upper chamber with respect to an inside circumference of the top portion.

When the upper chamber 102 may be coupled with the top portion 101, the first and second pluralities of teeth may have the inner side of the tooth facing an outside side of the tooth. A gap between abutting edges of teeth oriented about adjacent diameters may be about 0.35 mm to 0.75 mm which may result in a pinching and cutting action of the herbal material.

An inner side 161 facing the central axis 151, may be approximately parallel with an outside side 164 facing away from the central axis, and two sides, third and fourth sides, 163, 164, abutting the outside side and the inner side that form the four sides.

In the first mode of operation or the loading mode of operation when the upper chambers may be uncoupled from the top portion The herbal material may be inserted between the first and second pluralities of teeth, 111 and 112, respectively.

In a second mode of operation, or grinding mode of operation, the top portion may be engaged with the upper chamber and the first plurality of teeth and second plurality of teeth engage the unground herbs in between and the lower chamber comprising a second cavity 132, the lower chamber removably connected to the upper chamber, the plurality of aperture of the upper chamber communicating with the second cavity 132 of the lower chamber 103.

Referring to FIG. 1E, when the lower chamber may be coupled with the upper chamber and the top portion may be engaged with the upper chamber and in the second mode of operation, the top portion may be rotated about the central axis 151 (FIG. 1B) relative to the upper chamber and the lower chamber. Through this rotating action the herbal material may be ground between the first and second plurality of teeth as the herb grinder is operated in a reciprocating motion, where for example the top portion is rotated with respect of the upper chamber by approximately fifty degrees in a clockwise direction about the central axis 151 and then a hundred degrees in a counter clockwise direction and then reversed for example one hundred degrees and this operation is repeated a plurality of times, until substantial amount of the herbal material, passes into the second cavity or chamber from the upper chamber 102. Referring to FIG. 1E, the top portion may 101 may be rotated about the central axis 151 with respect to the lower chamber 103.

The ground material may then pass through the apertures 140 that may be formed in the lower part of the upper chamber into the second cavity of the lower chamber. Preferably the apertures 140 that are formed in the upper chamber are approximately 4 mm to 5 mm in diameter. Further preferably the apertures 140 may be about 4.5 mm in diameter. The ground material may pass under the influence of gravity through the aperture that may be formed in the lower part of the upper chamber into the second cavity of the lower chamber or through being moved by the first plurality of teeth from the top portion. FIG. 1G illustrates the plurality of apertures 140 from the top view. In some embodiments the apertures are of equal diameter. Having equal diameter apertures, facilitates for the ground herbal material to have an approximately similar particle size. In some embodiments the apertures 140 may not be present and the ground material may remain stored within the first cavity 131 and proximate the second plurality of teeth and the lower surface 102b and may be removed from the first cavity 131 through inverting of the first cavity 131.

Referring to FIG. 1C and FIG. 1B, a spout 104 or a sloped cavity may be formed by an edge wall and an upper surface 103a of the lower chamber, the spout having an open position allowing passage of the ground herbs out of the lower chamber cavity when the upper chamber may be uncoupled from the lower chamber, and having a closed position substantially preventing passage of the ground herbs out of the second cavity of the lower chamber when the upper chamber may be coupled with the lower chamber. The spout may have a sloping floor, sloping towards the central axis of the herb grinder.

FIG. 1B illustrates the having a closed position preventing passage of the ground herbs out of the second cavity of the lower chamber when the upper chamber may be coupled with the lower chamber. Where FIG. 1A shows the open position where the upper chamber may be coupled with the lower chamber.

Using the spout for example in combination with a finger or a tool may allow for the ground herbal material to be slid into a vaporizer device via the spout or into a container. With the spout the ground material being taken from the second cavity through the ground material being focused through the spout into where this may facilitate dispensing of the ground herbal materials.

Referring to FIG. 1D, the herb grinder 100 is shown from where the top portion and the lower chamber and the upper chamber are coupled together and the herb grinder 100 in accordance with an embodiment of the invention a housing of the herb grinder 100 may resemble an approximately egg or ovate shape for an outside surface 101s and 103s thereof, when viewed from the top view that is perpendicular to the central axis. The top portion 101 may have the outside surface 101s and the lower chamber 103 may have the outside surface 103s.

In an ovate shape when looking from the top view, the grinder may have a rounded base side 100s having a first radius 181 bisected by a first axis 191 and a second radius 182 bisected by second axis 192. The second axis 192 may be approximately perpendicular to the first axis 191. The oval shape of the grinder may be formed from a cuboid having each of the four vertical corners radiused. This may be achieved through a machining or injection moulding operation.

A second radius 182 may be found opposite the first radius 181 along and bisected by the first axis 191. A perpendicular radial axis 192 includes third and fourth radii 183, 184 where the third radius 183 may be may be larger than the first radius 181 and fourth radius 184 which may be larger than the second radius 182 with the second radius 182 may be smaller than the third radius 183 and the fourth radius 184 and first radius 181. The first through fourth radii may apply to the top portion 101 outside surface 101s and the lower chamber 103 outside surface 103s. The first and second axis 191 and 192 may radially extend from the central axis 151 (FIG. 1B).

The oval shape, may facilitate usage by an end-user, where the outside surfaces of the top portion 101 outside surface 101s may be placed in a left hand and the lower chamber 103 outside surface 103s may be placed in a right hand with the thumbs of the user placed proximate the second radius 182, and the fourth 184 and first radius 181, may rest in the palms of the user with the user's fingers grasping proximate the outside surfaces proximate the third radius 183.

The herb grinder housing may be made from metals, plastics, composites, wood, and the like and the housings may be separated from the first and second pluralities of teeth which may be manufacture from a metal material. Optionally the first plurality of teeth are formed from a metal material and the top portion may be formed from a plastic material or a non metallic material and the lower chamber may be also formed from a non metal material.

In some embodiments the grinder may be coated with a non-stick ceramic type material to prevent the ground material the ground herbs from sticking to the inside surfaces of the grinder. In some embodiments the first and second pluralities of teeth may be coated with a non-stick ceramic type material to prevent the ground material the ground herbs from sticking to the inside surfaces of the grinder.

Referring to FIG. 1D and FIG. 1E, the advantages of having the ovate shape enable ergonomic holding of the grinder within the hands of a user and because of this configuration it enables the end-user to get more purchase on the grinder form when grinding of dense herbal materials and reduce slippage within their hands.

Cylindrical or rounded shape grinders, may not allow for easy gripping of outside surface of the grinder as the round outside surface may slip within the hands of the user. There are other cuboid type grinders on the market, however these are not as ergonomic and do not as easily fit into a user's hands as the ovoid shape in accordance with embodiments of the invention.

Referring to FIG. 1C, in some embodiments there are protrusions 186 protruding from the lower chamber for engaging receptacles 187 in the upper chamber. The protrusions are for preventing the upper chamber from rotating about the central axis 151 with respect to the top portion as well as the lower chamber during grinding operation.

Referring to FIG. 1C, the upper chamber is shown uncoupled with the lower chamber and in some embodiments there may be a central member 151s that acts as a magnetic holder that protrudes from an approximate center of the lower chamber to magnetically engage the upper chamber where in the upper chamber has a magnet to engage the top portion.

The top portion may contain a first magnet 171 and the upper chamber may contain a second magnet 172 with a second magnet 172 of the upper chamber may be for facing the first magnet of the top portion and for magnetically coupling therewith.

The upper chamber may also contain a third magnet (not shown) and the lower chamber may contain fourth magnet 174 where the third and fourth magnets are for magnetically engaging each other and the lower chamber may comprise a pedestal 151s for holding of the fourth magnet. Optionally the upper chamber contains a single magnet for coupling the first magnet of the top portion and for a magnetic coupling of the fourth magnet from the lower chamber.

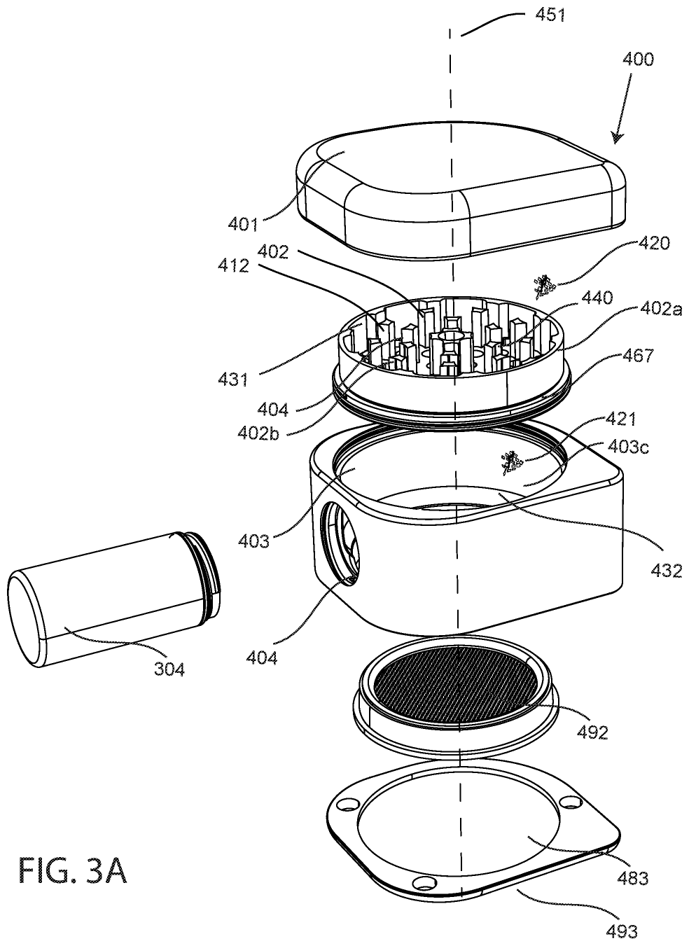

In some embodiments the upper chamber 102 and the lower chamber 103 may be coupled using a threaded engagement 467 or a bayonet type engagement as is shown in FIG. 3A.

The diameter and size of the apertures may be formed in the upper chamber may be size preferably such that the ground material that's coming into the second cavity from the first cavity may be sized symmetrically. Preferably the size may be ideal for vaporization where this can be used and either convection or conduction vaporizing device.

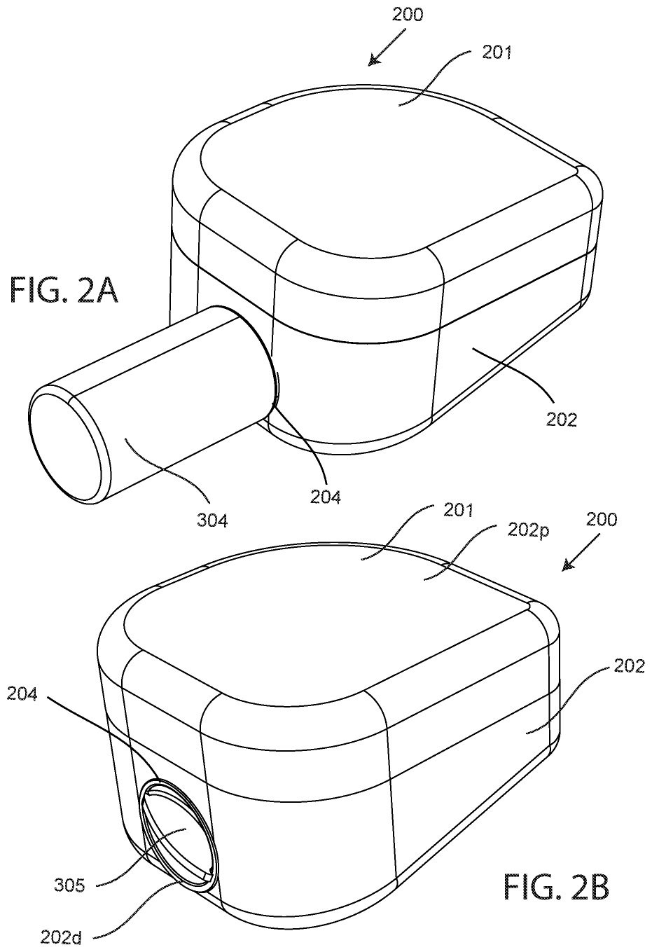

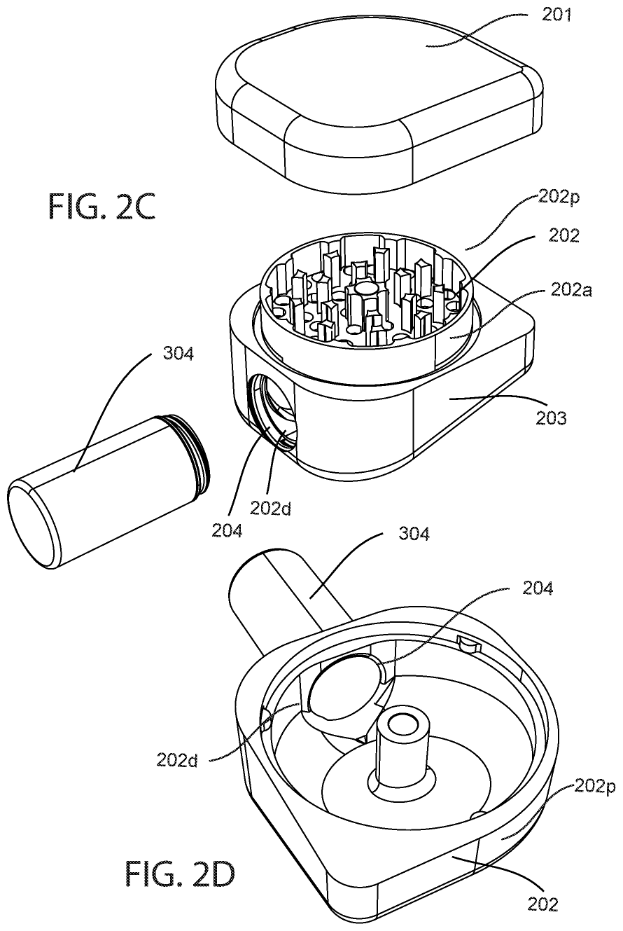

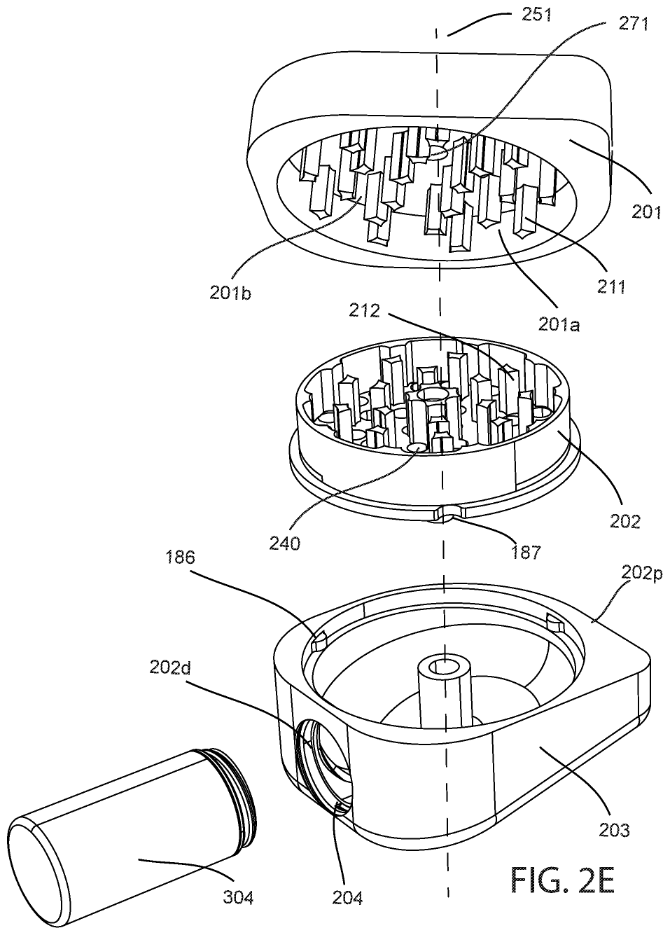

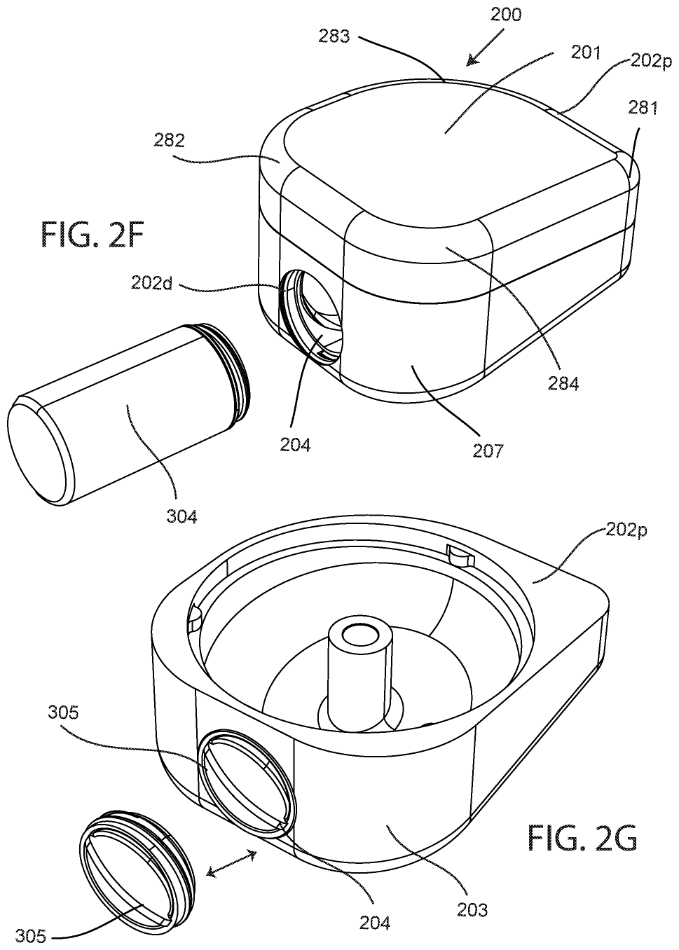

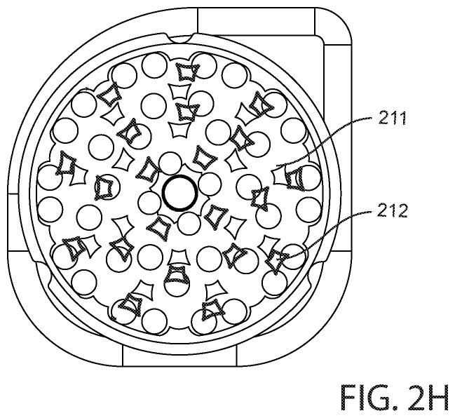

Referring to FIG. 2A a herb grinder 200 is shown in a closed view in accordance with a second embodiment of the invention with a storage container attached. The herb grinder 200 may be formed from a top portion 201 and upper chamber 202 and a lower chamber 203 and a filling container aperture 204.

The top portion 201 comprising a first plurality of teeth 211 (FIG. 2E) protruding from a bottom surface 201b of the top portion towards an upper chamber 202. The upper chamber 202 may be rotatably coupled with a magnetic connection to the top portion 201 where the upper chamber may be for forming a first cavity 231 into which a phyto or herbal material for grinding 420 may be placed.

A second plurality of teeth 212 protruding from a lower surface 202b of the first cavity 231, extending axially towards the first plurality of teeth 211 of the top portion 201. A plurality of apertures 240 being defined by the lower surface 202b of the first cavity 231 that passes through the upper chamber 202, the aperture allowing ground herbs 421 to exit the upper chamber 202 once ground.

When the upper chamber may be coupled with the top portion and an outer circumference 202a of the upper chamber 202 couples with an inside circumference 201a of the top portion. In the first mode of operation or the loading mode of operation when the upper chambers may be uncoupled from the top portion the herbal material may be inserted between the first and second pluralities of teeth, 211 and 212. The first mode of operation may be illustrated in FIG. 2C. FIG. 2D illustrates the storage container 304 attached with the filling container aperture 204 and an upper chamber removed 202.

In a second mode of operation as shown in FIG. 2A, the top portion may be engaged with the upper chamber and the first plurality of teeth and second plurality of teeth engage the herbs in between and the lower chamber comprising a second cavity 232, the lower chamber removably connected to the upper chamber, the plurality of aperture of the upper chamber communicating with the second cavity 232 of the lower chamber 203. The first and second plurality of teeth, maybe similar to those shown in the embodiment of FIGS. 1A through 1H.

When the lower chamber may be coupled with the upper chamber and the top portion may be engaged with the upper chamber and in the second mode of operation, the top portion may be rotated about a central axis 251 relative to the upper chamber and the lower chamber. Through this rotating action the herbal material may be ground between the first and second plurality of teeth. The ground material then passes through a plurality of apertures 240 formed in the lower part of the upper chamber into the second cavity of the lower chamber. Preferably the apertures that are formed in the upper chamber are approximately 4 mm to 5 mm in diameter. Further preferable the apertures are about 4.5 mm in diameter.

A filling container aperture 204 formed by an edge wall of the lower chamber, the filling container aperture 204 having an open position allowing passage of the ground herbs out of the lower chamber cavity (as shown in FIG. 2C) where the storage container 304 may be for being magnetically coupled or coupled with a threaded connection with the storage container 304.

The storage container for being releasably coupled with the filling container aperture for collecting the ground herbs. The storage container may be releasably coupled using either a magnetic or a threaded connection.

Referring to FIG. 2D, when viewed from a top view of the grinder 200 where the top portion and a lower chamber of the upper chamber are all coupled together the grinder resembles an approximately egg or ovate shape or a leaf shape or an ovate shape when looking at top view, the grinder has a base having a first radius 281 and has the widest point of the ovate shape below the middle of the leaf shaped grinder. A second radius 282 may be found opposite the first radius 281 along a same radial axis 291. A perpendicular radial axis 292 includes third and fourth radii 283, 284 where the third radius may be larger than the first and fourth radius which may be larger than the second radius with a second radius may be smaller than the third, fourth and first radius 281. FIG. 2E illustrates an exploded view of the second embodiment of the invention with the storage container 304 attached with the filling container aperture 204. Referring to FIG. 2F from a perspective view the ovate shape of the herb grinder is shown.

FIG. 2C illustrates a storage container removed from a filling container aperture and a top portion removed to show a second plurality of teeth where being able to easily store the ground leaf materials within the grinder may be also be advantageous. Having a storage container that may be coupled to the second cavity allows the ground phyto material to be transferred directly into the container through tapping or some other operation. Preferably in some embodiments the second cavity may be sloped from a distal end 202d to a proximal end 202p (FIG. 2C), proximal to the storage container, such that the ground herb material can easily be transferred into the storage container through the filling container aperture 204.

FIG. 2B illustrates the herb grinder 200 the storage container 304 removed and when the storage container 304 is not used with the grinder 200, a plug or a lid 305 may be inserted into the filling container aperture 204 to prevent the ground materials from falling out from the filling container aperture 204. The storage container 304 may also include a threaded lid (not shown) that can be attached to a mouth of the storage container 304 to allow containing of ground phyto material that may be disposed therein. FIG. 2G shows the plug or the lid 305 being removably attached with the filling container aperture 204.

FIG. 2H illustrates the first plurality of teeth 211 and the second plurality of teeth 212 being interdigitated when the top portion 201 is coupled with the upper chamber 202, this may also apply to the first and second embodiments of the invention.

Referring to FIG. 3A, another embodiment of the invention is shown as a herb grinder 400 in accordance with a third embodiment of the invention where the herb grinder 400. The herb grinder 400 is shown in an exploded view. The herb grinder 400 may be formed from a top portion 401 and upper chamber 402 and a lower cavity 403c that forms a lower chamber 403 in conjunction with a lower chamber lid 493 and a filling container aperture 404.

The top portion 401 comprises a first plurality of teeth, similar to first plurality of teeth 111 protruding from a bottom surface (not visible in this figure and similar to that shown in FIG. 1A) of the top portion towards an upper chamber 402. The upper chamber 402 may be rotatably coupled with a magnetic connection to the top portion 401 where the upper chamber may be for forming a first cavity 431 into which a phyto or herbal material for grinding 420 may be placed.

A second plurality of teeth 412 may protrude from a lower surface 402b of the first cavity 231, extending axially towards the first plurality of teeth of the top portion 401. A plurality of apertures 440 being defined by the lower surface 402b of the first cavity 431 that passes through the upper chamber 402, the aperture allowing ground herbs 421 to exit the upper chamber 402 once ground.

When the upper chamber may be coupled with the top portion and an outer circumference 402a of the upper chamber 402 couples with an inside circumference of the top portion.

In the first mode of operation or the loading mode of operation when the upper chamber 402 may be uncoupled from the top portion 401 the unground herbal material 420 may be inserted between at least one of the first and second pluralities of teeth.

In a second mode of operation the top portion 401 may be engaged with the upper chamber 402 and the first plurality of teeth and second plurality of teeth engage the herbs 420 in between and the lower chamber comprising a second cavity 432, the lower chamber removably connected to the upper chamber, the plurality of aperture of the upper chamber communicating with the second cavity 432 of the lower chamber 403. The first and second plurality of teeth, maybe similar to those shown in the embodiment of FIGS. 1A through 1H.

When the lower chamber may be coupled with the upper chamber and the top portion may be engaged with the upper chamber and in the second mode of operation, the top portion may be rotated about a central axis 451 relative to the upper chamber and the lower chamber. Through this rotating action the herbal material may be ground between the first and second plurality of teeth. The ground material then passes through a plurality of apertures 440 formed in the lower part of the upper chamber into the second cavity of the lower chamber. Preferably the apertures that are formed in the upper chamber are approximately 4 mm to 5 mm in diameter. Further preferable the apertures are about 4.5 mm in diameter.

A filling container aperture 404 formed by an edge wall of the lower chamber, the filling container aperture 404 having an open position allowing passage of the ground herbs out of the lower chamber cavity where the storage container 304 may be for being magnetically coupled or coupled with a threaded connection with the storage container 304.

The storage container for being releasably coupled with the filling container aperture for collecting the ground herbs. The storage container may be releasably coupled using either a magnetic or a threaded connection. Similarly that shown in FIG. 2D, the third embodiment of the invention, when viewed from a top view of the grinder 400 where the top portion and a lower chamber of the upper chamber are all coupled together the grinder resembles an approximately egg or ovate shape or a leaf shape as is aforementioned.

The lower cavity 403c that forms a lower chamber 403 in conjunction with a lower chamber lid 493 may have the lower chamber lid 493 engaged with the lower chamber 403 using a magnetic or a threaded coupling. A screen member 492 comprising a plurality of perforations that may be about 0.2 mm to 0.5 mm to about 1 mm in size may be disposed proximate the lower chamber lid 493 such that ground herbal material may contact the screen member 492 and the screen member may allow for some finer ground material to pass through the perforations and other ground material to rest on top of the screen member and for this material to then be propagated it to the filling container a picture for potential subsequent storage into the storage container 304.

With such a grinder, the ground herbal material may be first may be ground between the first and second pluralities of teeth and it then the material may fall through to the lower chamber 403, where finer particles fall into a fourth chamber 483 through the filter screen member 492.

In the third embodiment 400, the upper chamber 402 may be threaded with the lower chamber 403 and in some cases the upper chamber 402 may be magnetically coupled with the lower chamber 403.

In some embodiments a magnetic coupling strength between the lower chamber and the upper chamber may be greater than a magnetic coupling strength between the upper chamber and a top portion. This means that upon uncoupling the top portion from the upper chamber the upper chamber remains magnetically coupled to the lower chamber.

In some embodiments there may also be plastic or PTFE ring surrounding a periphery of the upper chamber where this ring may be in contact with the top portion and prevents metal on metal interaction between the top portion and the lower chamber where this spacer ring provides a small gap between the top portion and the lower chamber when the grinder assembled in a second mode of operation in the grinding mode.

Advantageously having the magnetic coupling between the top portion the upper chamber and the lower chamber and means it's easier for the end user to take the grinder part for cleaning, or during grinding operations or for removing of the ground herbal or phyto material. Further advantageously with the upper chamber coupled to the lower chamber the top portion can be removed with the upper chamber and lower chamber may serve as a storage container for storing the ground fighter material in the second cavity.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

What I claim is:

1. A herb grinder comprising:
a top portion comprising a first plurality of teeth protruding axially from a bottom surface of the top portion;
an upper chamber for receiving the protruding first plurality of teeth, the upper chamber rotatably coupled to the top portion, the upper chamber for forming a first cavity into which an herbal material for grinding may be placed;
the upper chamber comprising a second plurality of teeth protruding from a lower surface of the first cavity, extending axially towards the first plurality of teeth of the top portion,
a central axis common to the top portion and the upper chamber about which the first plurality of teeth are for rotating with respect to the second plurality of teeth in a reciprocating motion for shredding the herb material for grinding;
wherein some of the first plurality of teeth and some of the second plurality of teeth comprise five sides comprising an inner side facing the central axis and an outside side facing away from the central axis and third and fourth sides abutting the outside side and the inner side that form four sides and capped by a fifth side where the third and fourth sides may have an approximately same surface area and the first side may have a lower surface area than the third and fourth side and the second side having a larger surface area than the third and fourth sides,
wherein the first plurality of teeth and the second plurality of teeth are interdigitated when the top portion is coupled with the upper chamber,
wherein the edges abutting the sides, which are herbal material shredding edges may be approximately parallel with the axis of rotation.

2. A herb grinder according to claim 1 wherein the upper chamber comprises an inside circumference and wherein the top portion comprises an outer circumference wherein when the upper chamber may be coupled with the top portion, a gap may be formed about the inside circumference wherein the inside circumference has a smaller diameter than the outer circumference.

3. A herb grinder according to claim 1 comprising a plurality of apertures being defined by the lower surface of the first cavity that passes through the upper chamber, the aperture allowing ground herbs to exit the upper chamber once ground through at least some of the plurality of apertures.

4. A herb grinder according to claim 3 comprising a lower chamber comprising a second cavity, the lower chamber removably connected to the upper chamber, the plurality of aperture of the upper chamber communicating with the second cavity of the lower chamber.

5. A herb grinder according to claim 4 comprising a spout formed by an edge wall and an upper surface of the lower chamber, the spout having an open position allowing passage of the ground herbs out of the lower chamber cavity when the upper chamber may be uncoupled from the lower chamber, and having a closed position preventing passage of the ground herbs out of the second cavity of the lower chamber when the upper chamber may be coupled with the lower chamber.

6. A herb grinder according to claim 1 wherein when the herb grinder is viewed from a top view that is perpendicular with the central axis the herb grinder comprises an ovate shape.

7. A herb grinder according to claim 6 wherein the ovate shape comprises a cuboid structure having four radiused comprising a first radius, a second radius, a third radius and a fourth radius, wherein the second radius may be found opposite the first radius along and bisected by a first axis and a perpendicular radial axis bisects third and fourth radii where the third radius may be may be larger than the first radius and fourth radius may be larger than the second radius and the second radius may be smaller than the third radius and the fourth radius and first radius.

8. A herb grinder according to claim 4 comprising a filling container aperture formed by an edge wall of the lower chamber, the filling container aperture having an open position allowing passage of the ground herbs out of the lower chamber cavity and comprising a storage container for being releasably coupled with the filling container aperture for collecting the ground herbs and a lid for being releasably coupled with the filling container aperture when the storage container is other than coupled with the filling container aperture.

9. A herb grinder according to claim 1 wherein the first cavity may be magnetically connected to the top portion.

10. A herb grinder according to claim 1 wherein the bottom portion may be one of magnetically connected to the lower chamber and threaded connection to the low chamber.

11. A herb grinder according to claim 1 wherein at least one of the four sides may be concave and comprise a diameter of curvature.

12. A herb grinder according to claim 11 wherein the four sides may be concave and each comprise a diameter of curvature wherein the first side has a smaller diameter of curvature than the third and fourth side diameters of curvature and the second side has a diameter of curvature larger than the diameter of curvature than the third and fourth side.

13. A method of grinding phyto material comprising:
providing a grinder having a top portion comprising a first plurality of teeth protruding from a bottom surface of the top portion;
providing an upper chamber, the upper chamber rotatably coupled to the top portion, the upper chamber for forming a first cavity;
providing a second plurality of teeth protruding from a lower surface of the first cavity, extending towards the first plurality of teeth of the top portion;
placing unground phyto material into the first cavity proximate the second plurality of teeth;
interdigitating of the first plurality of teeth with respect to the second plurality of teeth;
crushing the unground phyto material between the top portion and the upper chamber and the lower surface where at least some of the first and second pluralities of teeth engage the unground herbal material;
providing a central axis common to the top portion and the upper chamber;
rotating of the first plurality of teeth with respect to the second plurality of teeth in a reciprocating motion about the central axis for shredding the phyto material for grinding;
wherein some of the first plurality of teeth and some of the second plurality of teeth comprise five sides comprising an inner side facing the central axis and an outside side facing away from the central axis and third and fourth sides abutting the outside side and the inner side that form four sides and capped by a fifth side where the third and fourth sides may have an approximately same surface area and the first side may have a lower surface area than the third and fourth side and the second side having a larger surface area than the third and fourth sides,
wherein the edges abutting the sides, which are herbal material shredding edges may be approximately parallel with the axis of rotation.

14. A method of grinding phyto material according to claim 11 comprising providing a plurality of apertures being defined by the lower surface of the first cavity that passes through the upper chamber, the aperture allowing ground herbs to exit the upper chamber once ground;

15. A method of grinding phyto material according to claim 12 providing a lower chamber coupled with the upper chamber, the lower chamber comprising a second cavity, the lower chamber removably connected to the upper chamber, the plurality of aperture of the upper chamber communicating with the second cavity of the lower chamber.

16. A method of grinding phyto material according to claim 12 comprising uncoupling of the lower chamber from the upper chamber and removing of the ground herbs from the second cavity.

17. A method of grinding phyto material comprising:
providing a grinder having a top portion comprising a first plurality of teeth protruding from a bottom surface of the top portion;
providing an upper chamber, the upper chamber rotatably coupled to the top portion, the upper chamber for forming a first cavity
placing unground herb material into the first cavity, a second plurality of teeth protruding from a lower surface of the first cavity, extending towards the first plurality of teeth of the top portion,
providing a plurality of apertures being defined by the lower surface of the first cavity that passes through the upper chamber, the aperture allowing ground herbs to exit the upper chamber once ground;
providing a lower chamber coupled with the upper chamber, the lower chamber comprising a second cavity, the lower chamber removably connected to the upper chamber, the plurality of aperture of the upper chamber communicating with the second cavity of the lower chamber;
crushing unground herbal material between the top portion and the upper chamber where the first and second pluralities of teeth engage the unground herbal material;
rotating the top portion and the upper chamber in opposite directions and thereby grinding the unground herbal material between the first and second pluralise of teeth, the ground herbs passing through the aperture into the second cavity of the lower chamber;
providing a filling container aperture formed by an edge wall of the lower chamber, the filling container aperture having an open position allowing passage of the ground herbs out of the lower chamber cavity into a mouth of the coupled filling container;
uncoupling of the storage container from the filling container aperture with the ground herbal material being stored in the storage container.
